(19) United States
(12) Patent Application Publication
(10) Pub. No.: US 2019/0204641 A1
(43) Pub. Date: Jul. 4, 2019

(54) DISPLAY PANEL AND DISPLAY DEVICE

(71) Applicant: HUIZHOU CHINA STAR OPTOELECTRONICS TECHNOLOGY CO.,LTD., Huizhou Guangdong (CN)

(72) Inventor: Chunchi CHEN, Huizhou Guangdong (CN)

(21) Appl. No.: 15/996,417

(22) Filed: Jun. 1, 2018

Related U.S. Application Data
(63) Continuation of application No. PCT/CN2018/074287, filed on Jan. 26, 2018.

(30) Foreign Application Priority Data
Dec. 28, 2017 (CN) 201711458765.X

(51) Int. Cl. G02F 1/1347; G02F 1/1335; G02F 1/135

(52) U.S. Cl. CPC G02F 1/1347; G02F 1/133528; G02F 1/133514; G02F 2201/16; G02F 1/133621; G02F 2001/133622; G02F 1/1358

(57) ABSTRACT

Provided is a display panel, which includes a first LCD panel and a second LCD panel. The first LCD panel is disposed in opposite to and atop the second LCD panel. Each sub-pixel of the first LCD panel is correspondingly aligned with each sub-pixel of the second LCD panel. The second LCD panel includes ferroelectric liquid crystals. Also provided is a display device having such display panel. The invention can effectively enhance the transmittance of the backlight and elevate the luminance, thereby reducing power consumption and saving cost.

### RELATED APPLICATIONS

This application is a continuation application of PCT Patent Application No. PCT/CN2018/074287, filed Jan. 26, 2018, which claims the priority benefit of Chinese Patent Application No. 201711458765.X, filed Dec. 28, 2017, which is herein incorporated by reference in its entirety.

### FIELD OF THE DISCLOSURE

The invention relates to the field of display technology, and more particularly to a display panel and a display device.

### BACKGROUND

With the evolution of of electro-optics and semiconductor technology, the progress of display technology has stimulated the flourishing development of flat panel display. For flat panel displays, liquid crystal display (LCD) has numerous advantageous characteristics in terms of high spatial utilization, low power consumption, null radiation, and low electromagnetic interference. Hence, liquid crystal display has become the mainstream in the display market.

Liquid crystal display usually consists of a LCD panel and a backlight module, in which the backlight module provides the LCD panel with illuminating lights for the LCD panel to display images. Nonetheless, the contemporary LCD panel has an unsatisfactory luminance, which would in turn drive the backlight module to provide more backlight. Under this condition, the power consumption of LCD would be elevated and the cost would be risen.

### SUMMARY

To address the problems encountered by the prior art, an object of the invention is to provide a display panel and a display device with enhanced luminance.

According to one aspect of the invention, a display panel is provided, which includes a first LCD panel and a second LCD panel disposed in opposite to each other, in which the first LCD panel is disposed atop the second LCD panel. Each sub-pixel of the first LCD panel is correspondingly aligned with each sub-pixel of the second LCD panel. The second LCD panel includes ferroelectric liquid crystals.

Furthermore, the first LCD panel includes a first lower polarizer, a first liquid crystal cell, and a first upper polarizer. The first lower polarizer is disposed on the second LCD panel, and the first liquid crystal cell is disposed on the first lower polarizer, and the first upper polarizer is disposed on the first liquid crystal cell.

Furthermore, the first liquid crystal cell includes: a first color filter substrate, a first array substrate, and a first liquid crystal layer. The first color filter substrate is interposed between the first upper polarizer and the first lower polarizer. The first array substrate is interposed between the first color filter substrate and the first lower polarizer. The first array substrate and the first color filter substrate are assembled in opposite to each other in the cell, and the first liquid crystal layer is interposed between the first array substrate and the first color filter substrate.

Furthermore, the second LCD panel includes a second lower polarizer, a second liquid crystal cell, and a second upper polarizer. The second liquid crystal cell is disposed on the second lower polarizer, and the second upper polarizer is disposed on the second liquid crystal cell. The first lower polarizer is disposed on the second upper polarizer. The second liquid crystal cell is not provided with a color filter and includes ferroelectric liquid crystals.

Furthermore, the second liquid crystal cell includes: a second substrate, a second array substrate, and a second liquid crystal layer. The second substrate is interposed between the second upper polarizer and the second lower polarizer. The second array substrate is interposed between the second substrate and the second lower polarizer. The second array substrate and the second substrate are assembled in opposite to each other in the cell. The second liquid crystal layer is interposed between the second array substrate and the second substrate. The second liquid crystal layer consists of ferroelectric liquid crystals.

According to another aspect of the invention, the invention provides a display device including a display panel as stated above and a backlight module disposed in opposite to the display panel. The backlight module faces the second lower polarizer.

Furthermore, the backlight module is a direct backlight module or an edge backlight module.

Furthermore, the backlight module is set to provide lights of different color during different field color sequence cycles.

Furthermore, the backlight module provides red-colored backlight for the display panel during a first field color sequence cycle within a frame time. The backlight module provides green-colored backlight for the display panel during a second field color sequence cycle within a frame time, and the backlight module provides blue-colored backlight for the display panel during a third field color sequence cycle within a frame time.

Furthermore, the backlight module includes red-light LED, green-light LED, and blue-light LED.

The advantageous effects of the invention: The display panel of the invention is able to enhance the transmittance of the backlight emitted from the backlight module, thereby enhancing the luminance of the display panel, reducing the power consumption, and saving cost.

### BRIEF DESCRIPTION OF THE DRAWINGS

The embodiments and other aspects, features and advantages of the invention will be more clearly understood by the descriptions below and the accompanying drawings. In the figures:

FIG. 1 is a schematic diagram showing the structure of a display panel according to an embodiment of the invention;

FIG. 2 is a schematic diagram showing the structure of a liquid crystal display according to an embodiment of the invention; and

FIG. 3 is a diagrammatic view illustrating the lights of different colors emitted from the backlight module during different field color sequence cycles within a frame time.

### DETAILED DESCRIPTION OF PREFERRED EMBODIMENTS

Next, an embodiment of the invention will be given by the following detailed descriptions and the accompanying drawings. Nevertheless, the invention can be fulfilled in various forms. Also, the invention should not be construed to be limited to the concrete embodiments described herein. On the contrary, these embodiments are proposed to illustrate the principles and practical applications of the invention, in order to allow an artisan skilled in the art to understand that various exemplary embodiments and various modifications to the embodiment can be made to adapt the invention for particular applications.

In the drawings, the thickness of layers and regions are exaggerated. Same reference numeral indicates same element throughout the specification and drawings.

It is to be understood that the phrases of “first” and “second” are used herein to address numerous elements of the invention. However, the number of those elements are not to be limited by such phrases. Such phrases are merely used to distinguish one element from the other element.

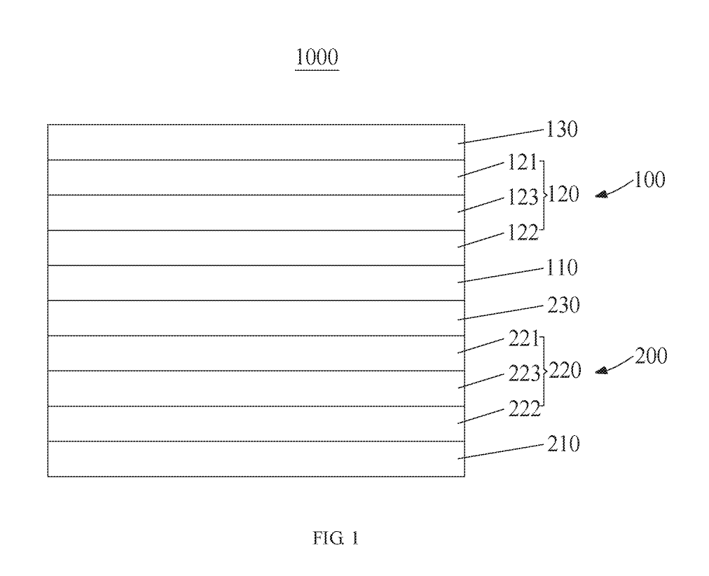

FIG. 1 schematically depicts the structure of a display panel according to an embodiment of the invention.

Please refer to FIG. 1. A display panel 1000 according to the invention includes a first LCD panel 100 and a second LCD panel 200. The first LCD panel 100 is opposite to the second LCD panel 200, and the first LCD panel 100 is securely disposed atop the second LCD panel 200.

In a preferred embodiment of the invention, after the first LCD panel 100 and the second LCD panel 200 are securely juxtaposed, each sub-pixel of the first LCD panel 100 is precisely aligned with each sub-pixel of the second LCD panel 200. This would prohibit the occurrence of interlaced shading. That is to say, each sub-pixel of the first liquid crystal 100 is correspondingly aligned with each sub-pixel of the second LCD panel 200.

Furthermore, in this embodiment the first LCD panel 100 includes a first lower polarizer 110, a first liquid crystal cell 120, and a first upper polarizer 130. Concretely speaking, the first lower polarizer 110 is disposed on the second LCD panel 200. The first liquid crystal cell 120 is disposed on the first lower polarizer 110. The first upper polarizer 130 is disposed on the first liquid crystal cell 120. In this embodiment, the relationship between the absorption axis of the first upper polarizer 130 and the absorption axis of the first lower polarizer 110 is determined according to whether the first LCD panel 100 is in the normal black mode or normal white mode, while the invention is not intended to put a limitation on this relationship.

Also, in this embodiment the first liquid crystal cell 120 includes: a first color filter substrate 121, a first array substrate 122, and a first liquid crystal layer 123. Concretely speaking, the first color filter substrate 121 is interposed between the the first upper polarizer 130 and the first lower polarizer 110. The first array substrate 122 is interposed between the first color filter substrate 121 and the first lower polarizer 110. The first array substrate 122 and the first color filter substrate 121 are assembled in opposite to each other in the cell. The first liquid crystal cell 123 is interposed between the first array substrate 122 and the first color filter substrate 121.

Here, the first color filter substrate 121 may include parts such as color filter films and black matrices. The first array substrate 122 may include essential parts such as thin-film transistors and pixel electrodes. The first liquid crystal layer 123 includes a number of liquid crystal molecules that are deflected by the voltage applied thereto to allow or disallow lights to pass therethrough. In an alternative embodiment of the invention, the color filter film is fabricated on the first array substrate 122 so as to form a COA (color filter on array) substrate.

Furthermore, in this embodiment the second LCD panel 200 includes: a second lower polarizer 210, a second liquid crystal cell 220, and a second upper polarizer 230. Concretely speaking, the second liquid crystal cell 220 is disposed on the second lower polarizer 210, and the second upper polarizer 230 is disposed on the second liquid crystal cell 220, and the first lower polarizer 110 is disposed on the second upper polarizer 230. In this embodiment, the relationship between the absorption axis of the second upper polarizer 230 and the absorption axis of the second lower polarizer 210 is determined according to whether the second LCD panel 200 is in the normal black mode or normal white mode, while the invention is not intended to put a limitation on this relationship. In addition, in this embodiment the second liquid crystal cell 220 is not provided with a color filter film. Also, the second liquid crystal cell 220 includes ferroelectric liquid crystals.

Also, in an embodiment of the invention the second liquid crystal cell 220 includes: a second substrate 221, a second array substrate 222, and a second liquid crystal layer 223. Concretely speaking, the second substrate 221 is interposed between the second upper polarizer 230 and the second lower polarizer 210, and the second array substrate 222 is interposed between the second substrate 221 and the second lower polarizer 210. The second array substrate 222 and the second substrate 221 are assembled in opposite to each other in the cell. The second liquid crystal layer 223 is interposed between the second array substrate 222 and the second substrate 221. Here, it is noteworthy that the second substrate 221 is different from a common color filter substrate in that the second substrate 221 does not include a color filter film that is provided in a common color filter substrate.

That is to say, the second substrate 221 may include essential parts other than color filter films, such as a black matrices. That is, the second substrate 221 has the same structure with a common color filter substrate except for a color filter film. The second array substrate 222 may include essential parts such as thin-film transistors and pixel electrodes. The second liquid crystal layer 223 includes a number of ferroelectric liquid crystal molecules that are deflected by the voltage applied thereto to allow or disallow lights to pass therethrough. Also, the ferroelectric liquid crystal molecules is featured by fast response characteristic.

FIG. 2 depicts the structure of a display device according to an embodiment of the invention.

Please refer to FIG. 2. The display device according to am embodiment of the invention includes a display panel 1000 and a backlight module 2000. The backlight module 2000 and the display panel are disposed in opposite to each other in order that the backlight module 2000 provides illuminating lights for the display panel 1000 to display images. Further, the backlight module 2000 faces the second lower polarizer 210.

Besides, in this embodiment the backlight module 2000 is a direct backlight module or an edge backlight module. However, it is not intended to put a limitation on the scope of the invention in terms of the type of the backlight module.

Furthermore, the backlight module 2000 is able to provide lights of different colors during different field color sequence cycles within a frame time.

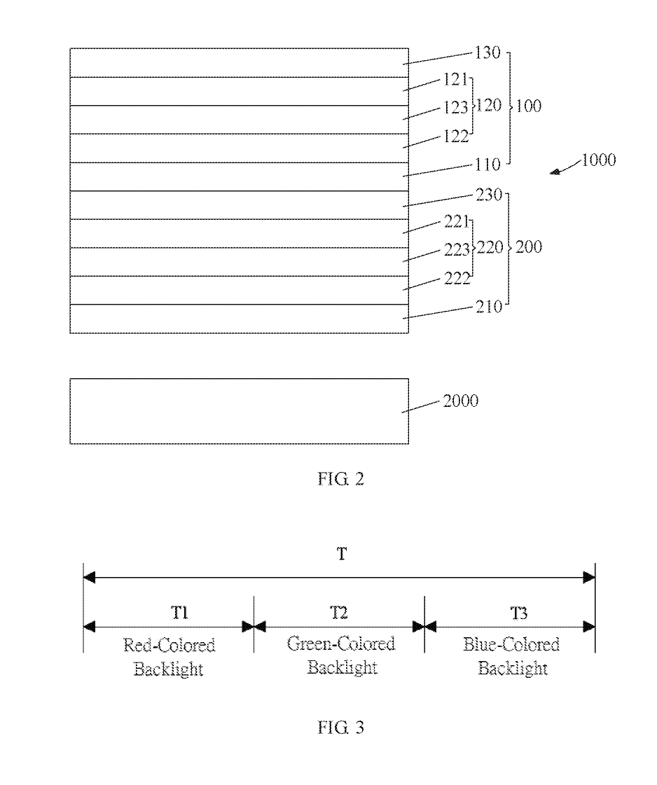

FIG. 3 is a diagrammatic view illustrating the lights of different colors emitted from the backlight module during different field color sequence cycles within a frame time.

Please refer to FIG. 3. the backlight module 2000 according to an embodiment of the invention is able to provide red-colored backlight for the display panel 1000 during of a first field color sequence cycle T1 within a frame time T. In addition, the backlight module 2000 according to an embodiment of the invention is able to provide green-colored backlight for the display panel 1000 during a second field color sequence cycle T2 within a frame time T. Also, the backlight module 2000 according to an embodiment of the invention is able to provide blue-colored backlight for the display panel 1000 during a third field color sequence cycle T3 within a frame time T. It is to be understood that the descriptions of the backlight module being able to emit lights of different colors during different field color sequence cycles within a frame time is to be taken as an exemplification. The scope of invention should not be limited to the precise formed disclosed herein. For example, the backlight module is able to emit red-colored backlight for the display panel 1000 during the second field color sequence cycle T2.

Therefore, the backlight module 2000 according to the invention may consist of a red-colored light source, a green-colored light source, and a blue-colored light source. Further, the red-colored light source may be a red-light LED, the green-colored light source may be a green-light LED, and a blue-colored light source may be a blue-light LED.

In conclusion, the display panel according to an embodiment of the invention is able to efficiently enhance the transmittance of the backlight and elevate the luminance, and thus reduce power consumption and save cost.

Though the invention has been explicated by giving a specific embodiment, an artisan skilled in the art may understand that various modifications on the forms and details of the embodiment can be made without departing from the spirit and scope of the invention. The scope of the invention is defined by the claims and their equivalents.

What is claimed is:

1. A display panel, comprising
a first liquid crystal display (LCD) panel; and
a second LCD panel;
wherein the first LCD panel and the second LCD panel are disposed in opposite to each other and the first LCD panel is disposed atop the second LCD panel, and wherein each sub-pixel of the first LCD panel is correspondingly aligned with each sub-pixel of the second LCD panel, and the second LCD panel includes ferroelectric liquid crystals.

2. The display panel according to claim 1, wherein the first LCD panel includes a first lower polarizer, a first liquid crystal cell, and a first upper polarizer, and wherein the first lower polarizer is disposed on the second LCD panel, the first liquid crystal cell is disposed on the first lower polarizer, and the first upper polarizer is disposed on the first liquid crystal cell.

3. The display panel according to claim 2, wherein the first liquid crystal cell includes a first color filter substrate, a first array substrate, and a first liquid crystal layer, and wherein the first color filter substrate is interposed between the first upper polarizer and the first lower polarizer, the first array substrate is interposed between the first color filter substrate and the first lower polarizer, the first array substrate and the first color filter substrate are assembled in opposite to each other in the first liquid crystal cell, and the first liquid crystal layer is interposed between the first array substrate and the first color filter substrate.

4. The display panel according to claim 2, wherein the second LCD panel includes a second lower polarizer, a second liquid crystal cell, and a second upper polarizer, and wherein the second liquid crystal cell is disposed on the second lower polarizer, the second upper polarizer is disposed on the second liquid crystal cell, the first lower polarizer is disposed on the second upper polarizer, and the second liquid crystal cell is not provided with a color filter and the second liquid crystal cell includes ferroelectric liquid crystals.

5. The display panel according to claim 3, wherein the second LCD panel includes a second lower polarizer, a second liquid crystal cell, and a second upper polarizer, and wherein the second liquid crystal cell is disposed on the second lower polarizer, the second upper polarizer is disposed on the second liquid crystal cell, the first lower polarizer is disposed on the second upper polarizer, and the second liquid crystal cell is not provided with a color filter and the second liquid crystal cell includes ferroelectric liquid crystals.

6. The display panel according to claim 4, wherein the second liquid crystal cell includes a second substrate, a second array substrate, and a second liquid crystal layer, and wherein the second substrate is interposed between the second upper polarizer and the second lower polarizer, the second array substrate is interposed between the second substrate and the second lower polarizer, the second array substrate and the second substrate are assembled in opposite to each other in the second liquid crystal cell, the second liquid crystal layer is interposed between the second array substrate and the second substrate, and the second liquid crystal layer includes ferroelectric liquid crystals.

7. The display panel according to claim 5, wherein the second liquid crystal cell includes a second substrate, a second array substrate, and a second liquid crystal layer, and wherein the second substrate is interposed between the second upper polarizer and the second lower polarizer, the second array substrate is interposed between the second substrate and the second lower polarizer, the second array substrate and the second substrate are assembled in opposite to each other in the second liquid crystal cell, the second liquid crystal layer is interposed between the second array substrate and the second substrate, and the second liquid crystal layer includes ferroelectric liquid crystals.

8. A display device, comprising a display panel as claimed in claim 1 and a backlight module disposed in opposite to the display panel, wherein the backlight module faces a second lower polarizer of the display panel.

9. The display device according to claim 8, wherein the backlight module is a direct backlight module or an edge backlight module.

10. The display device according to claim 8, wherein the backlight module is set to provide lights of different colors during different field color sequence cycles.

11. The display device according to claim 9, wherein the backlight module is set to provide lights of different colors during different field color sequence cycles.

12. The display device according to claim 10, wherein the backlight module is set to provide red-colored backlight for the display panel during a first field color sequence cycle within a frame time, and provide green-colored backlight for the display panel during a second field color sequence cycle within a frame time, and provide blue-colored backlight for the display panel during a third field color sequence cycle within a frame time.

13. The display device according to claim 11, wherein the backlight module is set to provide red-colored backlight for the display panel during a first field color sequence cycle within a frame time, and provide green-colored backlight for the display panel during a second field color sequence cycle within a frame time, and provide blue-colored backlight for the display panel during a third field color sequence cycle within a frame time.

14. The display device according to claim 12, wherein the backlight module includes a red-light light-emitting diode (LED), a green-light LED, and a blue-light LED.

15. The display device according to claim 13, wherein the backlight module includes a red-light LED, a green-light LED, and a blue-light LED.
